(19) United States
(12) Patent Application Publication
(10) Pub. No.: US 2026/0140596 A1
(43) Pub. Date: May 21, 2026

(54) VALUATION OF VIRTUAL SPACES IN A VIRTUAL ENVIRONMENT BASED ON USER INTERACTION

(71) Applicant: INTERNATIONAL BUSINESS MACHINES CORPORATION, ARMONK, NY (US)

(72) Inventors: Aravind Ragupathi, Cary, NC (US); Martin G. Keen, Cary, NC (US); Jeremy R. Fox, Georgetown, TX (US); Hamid Majdabadi, OTTAWA (CA)

(21) Appl. No.: 18/953,038

(22) Filed: Nov. 19, 2024

(51) Int. Cl. G06F 3/04815; G06F 3/01; G06Q 30/0241; G06Q 50/16

(52) U.S. Cl. CPC G06F 3/04815; G06F 3/013; G06Q 30/0241; G06Q 50/16

(57) ABSTRACT

Dynamic valuation of virtual spaces in a virtual environment includes receiving telemetry data describing current user interactions with a virtual environment; performing predictive analysis on the telemetry data to predict future user interactions with a plurality of virtual spaces in the virtual environment; and continually adjusting values of the virtual spaces based on the predicted future user interactions without considering virtual objects in the plurality of virtual spaces.

### BACKGROUND

### TECHNICAL FIELD

The present disclosure generally relates to virtual reality (VR), and more particularly, to valuation of virtual spaces in a virtual environment.

### DESCRIPTION OF THE RELATED ART

The “Metaverse” refers to a collective virtual shared space, autonomously created by a convergence of virtually enhanced physical reality and digitally reconstructed reality. Businesses are increasingly offering their products to customers in the Metaverse.

In physical retail space, a product’s visibility and subsequent sales are influenced by its placement. However, placement strategies for physical retail space are often not applicable to a freeform, non-geographical virtual space in the Metaverse.

### SUMMARY

According to various embodiments, a computer-implemented method, a computing device, and a non-transitory computer readable storage medium are provided for dynamic valuation of virtual spaces in a virtual environment. The dynamic evaluation includes receiving telemetry data describing current user interactions with a virtual environment; performing predictive analysis on the telemetry data to predict future user interactions with a plurality of virtual spaces in the virtual environment; and continually adjusting values of the virtual spaces based on the predicted future user interactions without considering virtual objects in the virtual spaces.

In some embodiments, the virtual spaces initially have a priori values, and the predicted future user interactions are used to adjust the values.

In some embodiments, strategic product placement of a plurality of virtual products within the virtual spaces is identified based on the values.

In some embodiments, a host of the virtual environment executes strategic product placement of the plurality of virtual products within the virtual spaces based on the values.

In some embodiments, executing the strategic product placement includes rendering the plurality of virtual products in high-value areas to increase visibility and likelihood of user engagement.

In some embodiments, the virtual environment includes virtual real estate, and the values after adjustment are utilized to influence virtual real estate pricing.

In some embodiments, the telemetry data includes user gaze patterns, user focus durations, and user spatial navigations, and the predicted future user interactions include duration of focus on a particular virtual space, and whether a return will be made to that particular virtual space.

In some embodiments, the telemetry data describing the current user interactions are collected by a plurality of agents at a corresponding plurality of end user devices.

In some embodiments, a machine learning model is used to predict the future user interaction. For example, the machine learning model includes a Random Forests model.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a computing environment, consistent with an illustrative embodiment.

FIG. 2 is a computer-implemented method, consistent with an illustrative embodiment.

FIG. 3 is an example of product placement in a virtual environment, consistent with an illustrative embodiment.

FIG. 4 illustrates a User Interaction Telemetry Data Collector including a plurality of agents, and also an example application for performing the computer-implemented method of FIG. 2, consistent with an illustrative embodiment.

FIG. 5 is a method performed by an agent, consistent with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

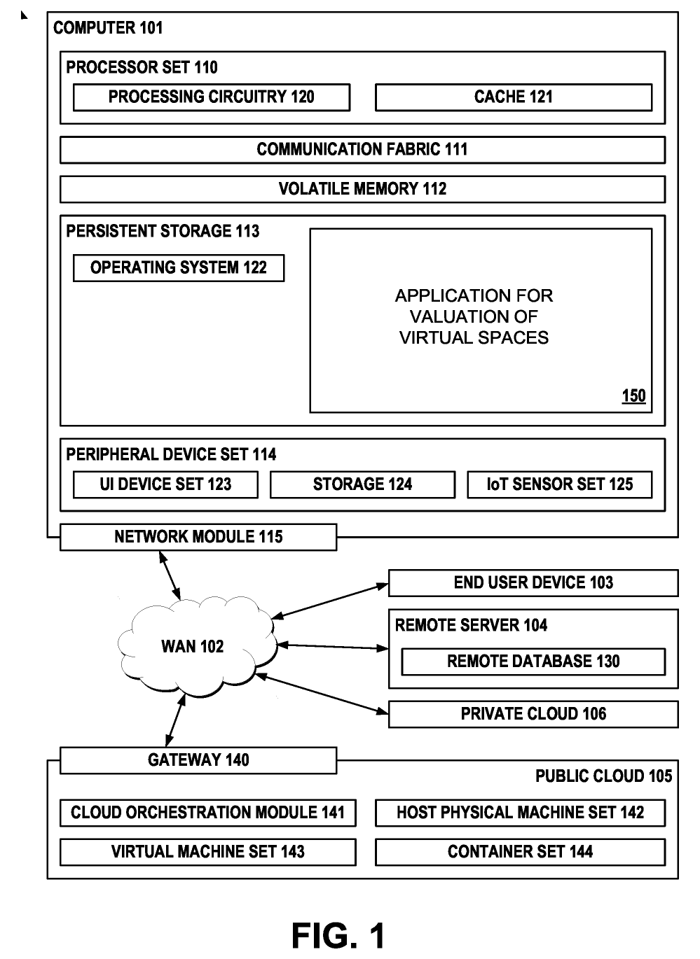

Reference is made to FIG. 1. A computing environment 100 includes an example of an environment for the execution of at least some of the computer code involved in performing the inventive methods. The computing environment 100 includes, for example, computer 101. The computing environment 100 may also include other features, such as a wide area network (WAN) 102, end user device 103, remote server 104, public cloud 105, and private cloud 106. In this embodiment, the computer 101 includes processor set 110, communication fabric 111, volatile memory 112, persistent storage 113 (including operating system 122 and application 150), peripheral device set 114 (including user interface (UI) device set 123, storage 124, Internet of Things (IoT) sensor set 125), and network module 115.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

At least some of the instructions for performing the inventive methods may be stored in persistent storage 113 as part of application 150. The instructions, when executed, cause the processor set 110 to perform the inventive methods, including valuation of virtual spaces in a virtual environment.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through a network. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. In some embodiments, remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example Virtual Environment

As used herein, a virtual environment (VE) refers to a networked application that allows a user to interact with both the computing environment and the work of other users. The VE may be collaborative, immersive, or augmented. A collaborative virtual environment supports real-time interaction between multiple users, often represented by avatars. An immersive virtual environment uses VR headsets and motion tracking to create a highly realistic environment. An augmented virtual environment combines virtual reality with augmented reality elements, where users can see and interact with virtual objects superimposed on the real world.

A virtual environment may be configured to display products. Such products are not limited to any particular types. Examples of such products include consumer goods, advertisements, virtual digital assets, and digital content.

The virtual environment for displaying the products is not limited to any particular type. Examples include a shopping mall, a retail store, a warehouse, a room, an entertainment center (e.g., a stadium or arena), a social space (e.g., social media), a virtual museum, an art gallery, an education campus, a trade floor, and a gaming environment.

The virtual environment contains various virtual spaces. As used herein, a virtual space refers to a three-dimensional volume or a two-dimensional area within the virtual environment that can be uniquely identified and valued. Virtual spaces may be fixed or dynamic in size, and may be contiguous or overlapping.

A virtual space may be occupied by one or more virtual objects, or the virtual space may be empty. The virtual objects that occupy these virtual spaces constitute the content of the virtual environment.

The computing environment 100 may host a virtual environment. For example, a virtual environment may be hosted by any of the computer 101, the end user device 103, the remote server 104, the public cloud 105, and the private cloud 106.

By virtue of the concepts discussed herein, valuation of virtual spaces within a virtual environment is performed. The valuation is based on predictions of future user interactions with the virtual spaces. As used herein, user interaction refers to active participation in a virtual environment. As used herein, user engagement refers to the depth of involvement a user has with a virtual environment and whether that user is valuing content in that virtual environment.

### Example Method

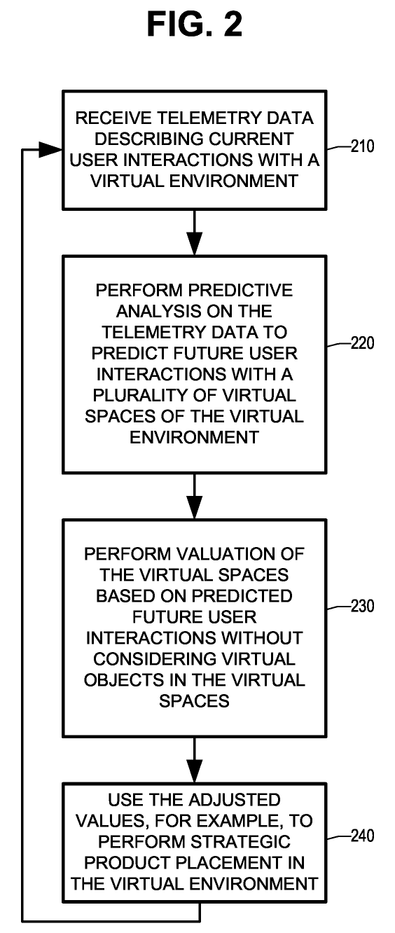

Reference is made to FIG. 2, which illustrates a computer-implemented method for performing dynamic valuation of virtual spaces in a virtual environment based on user interaction.

At block 210, telemetry data is received from one or more end user devices 103. The telemetry data describes current user interactions with the virtual environment. Examples of such current interactions include, without limitation, gaze patterns, focus durations, and spatial navigations.

At block 220, predictive analysis is performed on the telemetry data to predict future user interactions with a plurality of virtual spaces of the virtual environment. For example, examples of predicted future user interactions include how long a user stays focused on a particular virtual space, expected frequency of visits to that particular virtual space over time, probability of noticing nearby virtual spaces, and probable sequence of virtual space visits. A supervised machine learning model may be trained to process the telemetry data to produce these predictions.

At block 230, the valuation of virtual spaces in the virtual environment is performed. The valuation is based on the predicted future user interactions. The virtual spaces may initially be assigned a priori (e.g., baseline) values according to certain assumptions. Virtual spaces that are empty might be considered cold spots. Virtual spaces that include objects of attention might be considered warm spots. A priori values may be initially assigned to these spots, where warm spots have higher values than the cold spots. These assumptions may also be context-based. For example, if the virtual environment is an arena hosting an e-sports event such as a basketball game, hot spots might include court, baskets and players, while cold spots might include a fan section and rafters.

The predicted future user interactions are then used to adjust the values. If a number of users are predicted to observe a virtual space in the future, the value of that virtual space will be increased. Conversely, if a virtual space will not draw attention from any of the users, its value will be reduced.

The valuation adjustment is performed without considering virtual objects in the virtual spaces. By not relying on the virtual objects, adjustments are based on far less data. As a result, there is less data to transmit, less data to process, fewer inputs to the ML model, and greater flexibility in choosing a theory for the ML model. The savings in computational resources and computing efficiency are substantial.

At block 240, the adjusted values are used in the virtual environment. How the adjusted values are used will vary from use case to use case. Several examples of use cases are provided below.

Several of the use cases involve strategic product placement in a virtual environment according to the values. Virtual spaces having higher values suggest higher desirability to place products. This, in turn, increases the likelihood of user engagement with virtual objects in the virtual spaces. Thus, as the values are adjusted, products are moved out of low value spaces and placed in in high value spaces. The product placement may be performed by the entity hosting the virtual environment. For example, product placement values are transmitted to the host of the virtual environment, and the host performs the product placement

The values may change suddenly. Consider the example of the basketball game. During halftime, focus may shift from the baskets to center court, where a halftime show is being held. Values of virtual spaces including the baskets will be reduced during halftime, and values of virtual spaces at center court will be adjusted upwards. This will be done without considering the underlying reason for the shift.

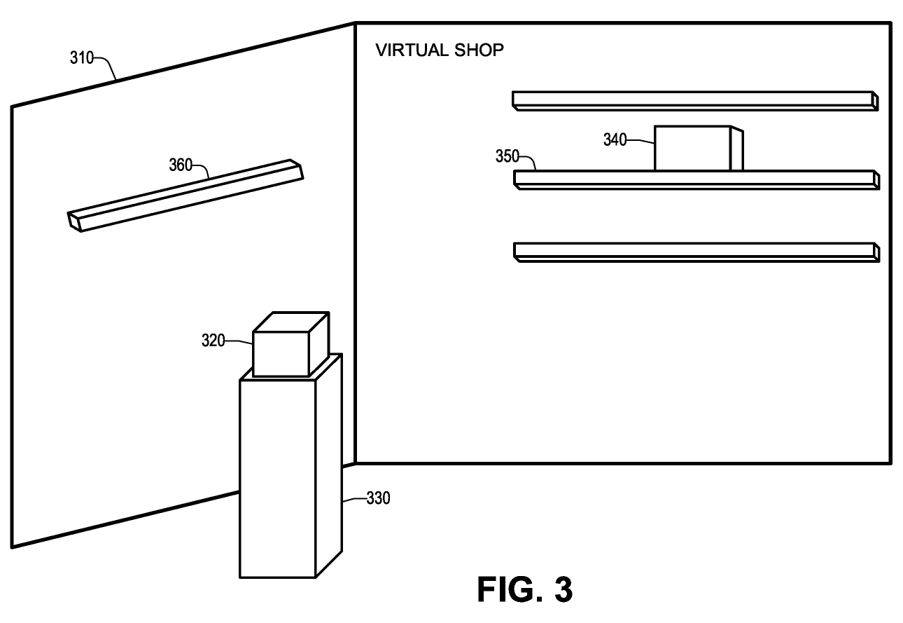

Consider another example of a virtual shop 310 illustrated in FIG. 3. The virtual shop 310 has a first product 320 prominently displayed on a stand 330, and a second product 340 on a shelf 350. Initial values are set according to certain baseline assumptions: eye level view is more valuable, center view is more valuable, and empty corners are least valuable. The virtual space at the center eye-level initially has the highest value, virtual spaces including the first and second products 320 and 340 initially have an intermediate initial value, while the virtual spaces including empty corners of the virtual shop 310 have the lowest initial value.

As the virtual shop 310 is being visited by users, the telemetry data indicates that the users focus their gaze on the first product 320. The prediction analysis indicates that the users will remain focused on the first product 320, and ignore the second product 340. A virtual space including the first product 320 will have the highest value, while the virtual space including the second product 340 will have a low value. A virtual space including a shelf 360 above the first product 320 has a higher value than the virtual space including the second product 340. By moving the second product 340 from the shelf 350 to the shelf 360, visibility is increased.

The valuation adjustment may be performed continually by returning control to block 210. The control may be returned immediately, or it may be returned after a period has elapsed to allow, for example, additional telemetry data to be received.

The product placement is continually adaptable according to evolving user behaviors. If current user interactions change, the valuations will be adjusted and the products will be moved, but this will be done without analyzing content changes.

### Examples of Use Cases

A first example use case involves a high-end furniture retailer who wants to showcase furniture in a virtual showroom. A method herein can find optimal spots in the virtual showroom based on user behavior analytics for different types of furniture. Strategic placement of more attractive furniture in the showroom can increase the chances of user engagement. The showroom being virtual, the furniture is not limited to placement on the floor.

A second example use case applies to an e-commerce platform that transitions into the Metaverse by creating a plurality of different virtual stores. Each store may be regarded as a virtual space, and a method herein takes cues from user interactions with the different stores and their virtual layouts, and continually adjusts values for the different stores. The values may be used to determine store rents, where the virtual spaces having the highest values also have the highest rents.

A third example use case involves a virtual shopping mall in a popular massively multiplayer online (MMO) game that has multiple vacant slots for merchants to showcase their products. There is a strong demand for these slots. A method herein can analyze telemetry of visitor gaze and duration of focus of different empty slots, predict behavior from the telemetry data, and valuate the slots and assign a dynamic pricing structure based on visitor interaction.

A fourth example use case involves social media. A method herein can be applied to virtual space management in Augmented Reality interfaces. For instance, user-focused content can be placed according to the values for maximum interaction.

The foregoing use cases were provided by way of example only, and not by way of limitation. It will be understand that various other use cases are applicable to the teachings herein.

Example Application 150 and User Interaction Telemetry Data Collector 410

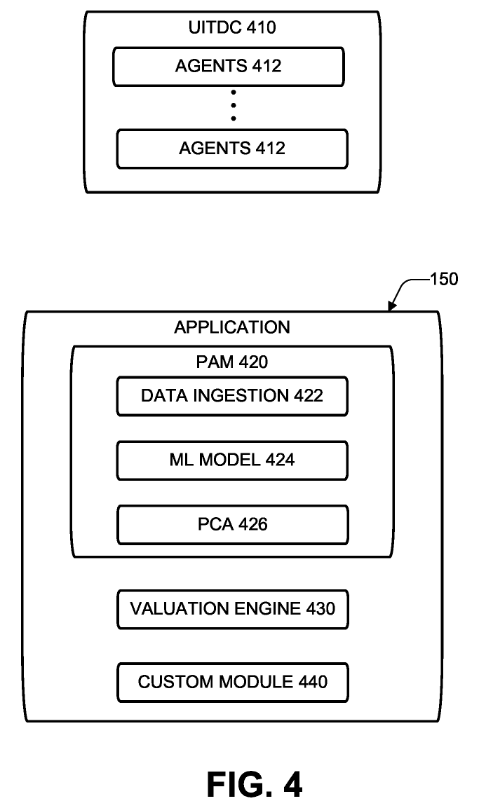

Reference is now made to FIG. 4, which illustrates a User Interaction Telemetry Data Collector (UITDC) 410. The UITDC 410 may include a plurality of agents 412 that reside on a corresponding plurality of EUDs 103. Each agent 412 includes code that, when executed by the EUD 103 on which it resides, uses event listeners and observer patterns to track and record user movements, clicks, gazes, touch interactions, durations of the touch interactions and other user interactions. For example, the agents 412 may make calls to WebXR and other application programming interfaces (APIs) that are standards defined by the World Wide Web Consortium (W3C) organizations. These APIs interact with an underlying VR engine (e.g., Unreal Engine, Unity) to capture values of these user interaction parameters. For example, the interface XRInputSourceChangeEvent in the WebXR API may be used to track changes in inputs.

The types of user interaction parameters available to the EUDs 103 will depend upon types of devices being used to interact with a virtual environment. For example, if an EUD 103 uses VR goggles, then the parameters may be derived from a specification sheet of the VR goggles. The parameters may include different data types such as Vector 2 for gaze pattern tracking, Vector 3 for spatial navigation, and timestamps for focus duration on specific objects.

In certain virtual environments, a user may be represented by an avatar. For those virtual environments, the collected data may include interactions between the avatar and the virtual environment.

Before the collected data is transmitted, it may be pre-processed. The pre-processing may include addressing missing values, treating outliers, and performing data normalization.

These pre-processed values may be placed in a standard format using protocols such as JavaScript Object Notation (JSON) or Extensible Markup Language (XML). The packaged data may then be transmitted to the computer 101 in packets via a protocol such as Transport Control Protocol (TCP) or User Datagram Protocol (UDP).

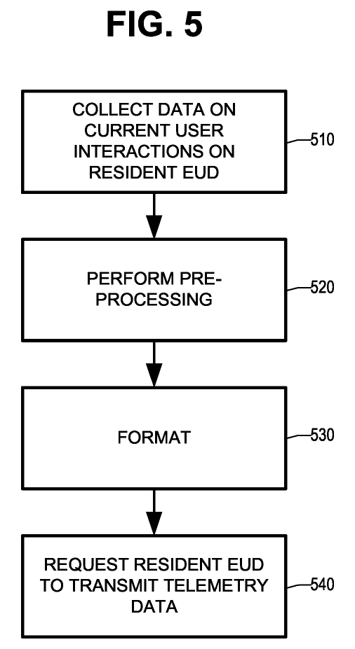

Additional reference is made to FIG. 5, which illustrates an example method that may be performed by an agent 412 residing on an EUD 103 (the “resident EUD”). At block 510, the agent 412 collect data on current user interactions on the resident EUD. At block 520, the agent 412 performs pre-processing on the collected data. At block 530, the agent 412 places results of the PCA in a standard format for transmission. At block 540, the agent 412 requests the resident EUD to transmit packetized telemetry data to the computer 101.

FIG. 4 further illustrates an example application 150, which resides on the computer 101. The example application 150 includes a Predictive Analysis Model (PAM) 420. The PAM 420 includes a data ingestion module 422 that receives and decodes the packetized telemetry data. Data that is received is cleaned and formatted. Non-numerical data may be transformed into numerical formats and scaled. An example of non-numerical data is user navigation paths that are represented as sequences of space identifiers. Specific Metaverse-related attributes, such as positional vectors, may also be transformed through normalization to a standard coordinate system and conversion to relative positions for cross-session comparison.

The PAM 420 may also include a module 426 that performs Principal Component Analysis (PCA). High dimensionality may result from multiple types of time series data such as gaze patterns and focus durations being collected from many agents. The PCA reduces the number of dimensions to help manage the volume of data from many agents tracking multiple interaction parameters over time.

The PAM 420 further includes a supervised machine learning (ML) model 424 that is trained to predict future user interaction. In some embodiments, the ML model 424 may include a Random Forests model, which identifies the most probable user navigations and interactions on a per-virtual space basis (as opposed to virtual objects within the virtual spaces). In general, Random Forests is an ensemble learning method for classification or regression. During training, a plurality of decision trees are created. Each tree is constructed using a random subset of the data set to measure a random subset of features in each partition. For classification tasks, the output of the Random Forests model is the class selected by most trees. For regression tasks, the output is the average of the predictions of the trees.

The ML model 424 may be trained on sets of labeled telemetry data. Examples of labels may include time spent in virtual space, return visit frequency, interaction counts, and normalized attention scores. During training, hyperparameters may be adjusted by methods such as grid search and random search. Examples of hyperparameters may include number of trees in the forest, maximum tree depth, minimum samples required to split an internal node, and number of features to consider for best split. The telemetry data may also be supplied back to the UITDC 410 as feedback for potential calibration or data collection enhancements, such as adjusting sensor sampling rates, optimizing gaze tracking thresholds, and refining spatial boundary definitions for more accurate user interaction measurements.

The Random Forests model is especially useful for accurately handling multidimensional and heterogenous data. However, the ML model 424 is not limited to a Random Forests model. Other models may be used. In some embodiments, the ML model 424may be a neural network.

The example application 150 further includes a valuation engine 430, which assigns values to virtual spaces in the virtual environment. Delta values may be calculated by combining multiple predictive attributes, such as user visit frequencies, average focus durations on objects, and overall visitor interaction for a specific area. The delta values are then added to the previous values to produce new values. Thus, when adjusting a previous value, V_{new} = Vₚᵣₑᵥᵢₒᵤₛ + ΔV. In this particular case, higher values indicate higher desirability.

The example application 150 may further include a custom module 440. Functions of the custom module 440 are customized according to a particular use case. If the use case involves product placement, the custom module 440 may use the scores to place products in virtual spaces of high value. If the use case involves virtual real estate, the custom module 440 can adjust rents of virtual spaces (e.g., virtual stores) based on the values from the valuation engine 430.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for dynamic valuation of virtual spaces in a virtual environment, the computer-implemented method comprising:
receiving telemetry data describing current user interactions with a virtual environment;
performing predictive analysis on the telemetry data to predict future user interactions with a plurality of virtual spaces in the virtual environment; and
continually adjusting values of the virtual spaces based on the predicted future user interactions without considering virtual objects in the plurality of virtual spaces.

2. The computer-implemented method of claim 1, wherein:
the virtual spaces initially have a priori values; and
the predicted future user interactions are used to adjust the a priori values.

3. The computer-implemented method of claim 1, further comprising identifying strategic product placement of a plurality of virtual products within the virtual spaces based on the values.

4. The computer-implemented method of claim 3, further comprising:
hosting the virtual environment; and
executing the strategic product placement of the plurality of virtual products within the virtual spaces based on the values.

5. The computer-implemented method of claim 4, wherein executing the strategic product placement includes rendering the plurality of virtual products in high-value areas to increase visibility and likelihood of user engagement.

6. The computer-implemented method of claim 1, wherein:
the virtual environment includes virtual real estate; and
the values are utilized to influence virtual real estate pricing.

7. The computer-implemented method of claim 1, wherein:
the telemetry data includes user gaze patterns, user focus durations, and user spatial navigations; and
the predicted future user interactions include duration of focus on a particular virtual space, and whether there will be a return to that particular virtual space.

8. The computer-implemented method of claim 1, wherein:
the telemetry data describing the current user interactions are collected by a plurality of agents at a corresponding plurality of end user devices.

9. The computer-implemented method of claim 1, wherein a machine learning model is used to predict the future user interactions.

10. The computer-implemented method of claim 9, wherein the machine learning model includes a Random Forests model.

11. A computer system comprising a memory having computer readable instructions; and one or more processors for executing the computer readable instructions to configure the computer system to perform a method comprising:
receiving telemetry data describing current user interactions with a virtual environment;
performing predictive analysis on the telemetry data to predict future user interactions with a plurality of virtual spaces in the virtual environment; and
continually adjusting values of the virtual spaces based on the predicted future user interactions without considering virtual objects in the virtual spaces.

12. The computer system of claim 11, wherein:
the virtual spaces initially have a priori values; and
the predicted future user interactions are used to adjust the a priori values.

13. The computer system of claim 11, wherein the method further comprises identifying strategic product placement of a plurality of virtual products within the virtual spaces based on the values.

14. The computer system of claim 11, wherein:
the telemetry data includes user gaze patterns, user focus durations, and user spatial navigations; and
the predicted future user interactions include duration of focus on a particular virtual space, and whether a return will be made to that particular virtual space.

15. The computer system of claim 11, wherein a machine learning model is used to predict the future user interactions.

16. A computer program product comprising one or more computer-readable memory devices encoded with data including instructions that, when executed, causes a processor set to carry out a method comprising:
receiving telemetry data describing current user interactions with a virtual environment;
performing predictive analysis on the telemetry data to predict future user interactions with a plurality of virtual spaces in the virtual environment; and
continually adjusting values of the virtual spaces based on the future user interactions without considering virtual objects in the virtual spaces.

17. The computer program product of claim 16, wherein:
the virtual spaces initially have a priori values; and
the predicted future user interactions are used to adjust the a priori values.

18. The computer program product of claim 16, wherein the method further comprises identifying strategic product placement of a plurality of virtual products within the virtual spaces based on the values.

19. The computer program product of claim 16, wherein:
the telemetry data includes user gaze patterns, user focus durations, and user spatial navigations; and
the predicted future user interactions include duration of focus on a particular virtual space, and whether a return will be made to that particular virtual space.

20. The computer program product of claim 16, wherein a machine learning model is used to predict the future user interactions.
